(19) United States
(12) Patent Application Publication
(10) Pub. No.: US 2013/0186220 A1
(43) Pub. Date: Jul. 25, 2013

(54) JACK SCREW FOR MOVING A MOVABLE PANEL OF A VEHICLE

(71) Applicants: Frank Kummer, Augsburg (DE); Dietmar Orth, Karlsfeld (DE)

(72) Inventors: Frank Kummer, Augsburg (DE); Dietmar Orth, Karlsfeld (DE)

(73) Assignee: VALEO SICHERHEITSSYSTEME GMBH, Erdweg (DE)

(21) Appl. No.: 13/807,471

(22) PCT Filed: Jun. 30, 2011
(86) PCT No.: PCT/EP2011/061000

§ 371 Date: Mar. 12, 2013

(30) Foreign Application Priority Data
Jul. 1, 2010 (EP) 10168110.4

(51) Int. Cl. F16H 25/20

(52) U.S. Cl. CPC F16H 25/2003
USPC 74/89.42

(57) ABSTRACT

The invention relates to a jack (4) for moving a movable panel of a vehicle, including: a endless screw and nut assembly (14) defining an axis (22); a bearing (20) in which an element (14) selected from the nut and the screw, for example the latter, is rotatably mounted; and a tensioner (60) which is force-tilted onto the element or onto the hearing and which biases the latter by means of mutual axial bearing when the jack is inoperative.

The invention relates to actuating jacks for movable panels of motor vehicles.

A jack of this kind is previously disclosed in particular in document EP-1 840 310. The jack comprises a nut and endless screw assembly for controlling the opening and the closing of the movable panel. A jack of this kind is subjected to high forces, which it transmits to the structure of the vehicle, in particular when there is a requirement for a movable rear panel to be actuated in an upward direction about a horizontal axis of rotation for the purpose of opening it. The coupling between the jack and the structure of the vehicle must be sufficiently robust for this purpose, however. There is also a wish for this to take place in the absence of free play between the component parts, in particular when the jack is inoperative with the movable panel closed. Such instances of free play are actually responsible for generating noise when the vehicle is in motion and give rise to the premature wear of certain component parts. Finally, it is preferable for the assembly of the coupling of the jack to the structure of the vehicle to take place in a simple and rapid manner with a reduced number of component parts and by adopting a sequence of easily implemented steps.

One object of the invention is thus to make available a coupling of the jack to the structure which is both robust, free from play and easy to assemble.

In order for this to happen, an actuating jack for a movable panel of a vehicle is proposed according to the invention, which comprises:
a nut and endless screw assembly defining an axis;
a bearing in which an element selected from the nut and the screw, for example the latter, is rotatably mounted; and
a tensioner which is force-fitted into the element or onto the bearing and which biases the latter by means of mutual axial bearing contact when the jack is inoperative.

Thus, thanks to the force-fitted tensioner, the jack is able to transmit high forces to the body of the vehicle. The jack is fixed to the bearing without free play, regardless of whether it is active or inoperative. In addition, the assembly of the component parts is particularly simple to perform.

Advantageously, the tensioner is force-fitted onto the bearing.

The tensioner preferably comprises tongues having an edge engaging with the element or the bearing.

Thus, a bias applied to the tensioner only serves to increase its engagement with the element or the bearing and thus to improve its attachment to the latter. Accordingly, this attachment will withstand loads of particularly high intensity.

The jack may additionally exhibit at least any one of the following characteristics:
the element is in bearing contact with the bearing by means of at least one surface inclined in relation to the axis;
the element and the bearing exhibit mutual bearing surfaces inclined in relation to the axis;
one or the other of the element and the bearing is in bearing contact with the tensioner by means of a surface inclined in relation to the axis; and
it comprises an adapter interposed between the tensioner and the bearing, preferably between the tensioner and the element, and exhibiting a bearing surface perpendicular to the axis and a bearing surface inclined in relation to the axis.

The one or more inclined surfaces ensure the centering of the component parts relative to one another, thereby facilitating their assembly and their installation.

The element and the bearing preferably form a ball joint coupling.

A degree of supplementary freedom of the element in relation to the bearing is obtained in this way, which reduces the risks of making the assembly statically indeterminate, as well as the loadings within the jack.

Advantageously, the element exhibits two surfaces in sequence along the axis of the bearing, inclined in relation to the latter and oriented in opposing directions.

This arrangement permits the element to contribute to the ball joint coupling.

Advantageously, the jack comprises at least one roller bearing interposed between the element and at least one or the other of the tensioner and the bearing, the one roller bearing or each roller bearing preferably having a generally frustoconical form.

Other characteristics and advantages of the invention will become more apparent from the following description of an embodiment given by way of example without limitation with reference to the drawings, in which:

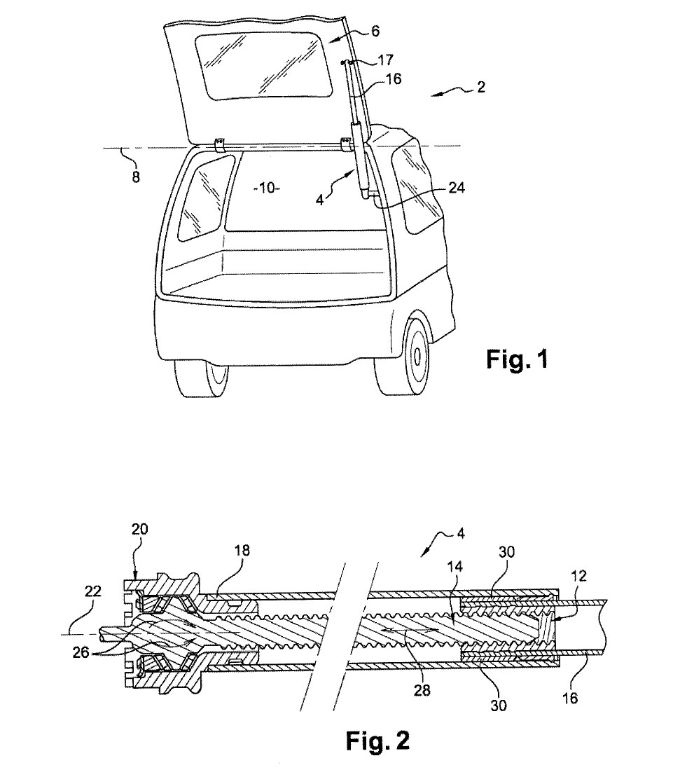

FIG. 1 is a partial perspective view of a vehicle equipped with a jack according to the invention for the operation of its rear movable panel and showing the latter in its open position;

FIG. 2 is a partial view in axial cross section of the jack in FIG. 1;

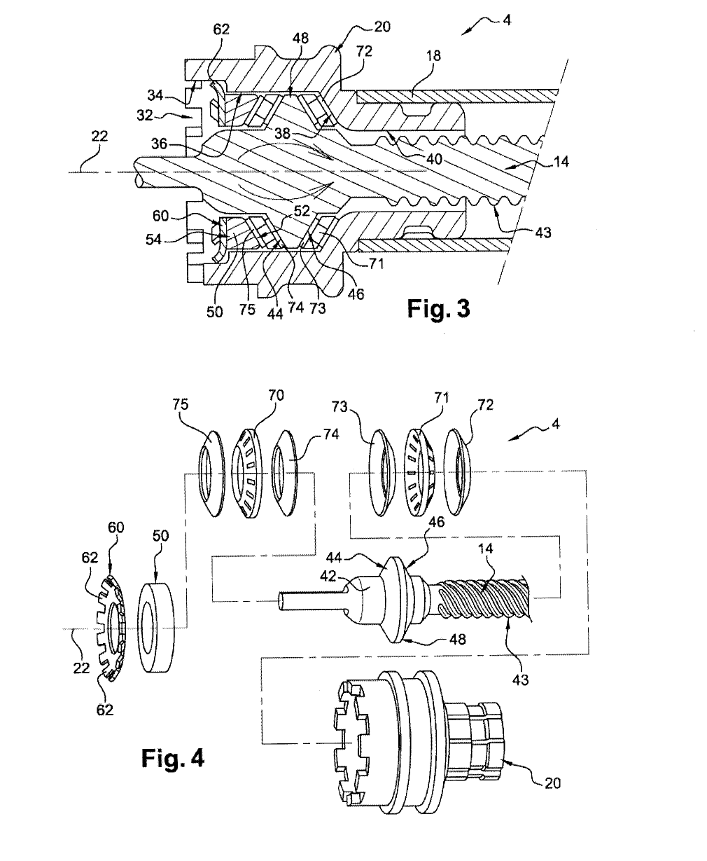

FIG. 3 is a view on a larger scale of a part of the jack in FIG. 2 and its bearing; and

FIG. 4 is an exploded perspective view of the elements in FIG. 3.

Illustrated in FIG. 1 is a motor vehicle 2 comprising a jack 4 according to the invention.

The latter permits the automatic operation of a movable panel 6 of the motor vehicle, which in this case is a rear tailgate mounted movably in rotation in relation to the structure of the vehicle about a horizontal axis 8 situated in the upper part of the movable panel in the closed state and the body. However, the movable panel opens by means of a movement towards the top and, in so doing, reveals a rear opening 10 leading into the interior of the vehicle.

Nevertheless, the jack can be used to move any door of the vehicle, and in particular the side doors, a front or rear luggage trunk or a front or rear engine compartment.

The jack, which will now be described with reference to FIGS. 2 to 4, is broadly similar to that already described in the aforementioned document EP-1 840 310, to which reference will be made for certain implementation details.

The jack 4 comprises an assembly of a nut 12 and an endless screw 14 in engagement one with the other by means of a helical screw-nut coupling. The nut 12 is rigidly fixed to a rod 16 of the jack at one extremity of the latter. The other extremity 17 of the rod is articulated on the movable panel 6. The jack comprises a frame 18 supporting a bearing 20, in which the screw is mounted movably in rotation about the principal axis 22 of the jack defined by the screw-nut coupling. The bearing 20 joins the frame 18 to the body of the vehicle by means of an articulated coupling 24. The jack comprises a motor, although it is not illustrated here, of which the housing is fixed in relation to the frame 18 and which ensures that the screw 14 is caused to rotate about the axis 22. This rotation, which is illustrated in FIG. 2 by the arrows 26, brings about the sliding of the nut 12 and the rod 16 depending on the direction of the axis 22, as illustrated by the double arrow 28. This sliding is made possible by blocking the rotation of the rod in relation to the frame 18. This blocking results in the engagement of reliefs 30 in the rod into longitudinal grooves in the frame 18.

We will now describe, principally with reference to FIGS. 3 and 4, the part of the jack adjacent to the bearing.

The bearing 20 is rigidly fixed to the frame 18. It exhibits, like the other component parts discussed below, a form possessing a rotational axis of symmetry about the axis 22, all of these component parts being coaxial. The bearing thus delimits a cavity 32 exhibiting the following internal surfaces in sequence along the axis 22 in the direction of the nut 12:
a cylindrical surface 34;
a cylindrical surface 36 having a radius smaller than the preceding radius and separated from the latter by a shoulder;
a frustoconical surface 38, of which the largest radius is equal to the radius of the cylindrical surface 36, and of which the radius reduces in the direction of the nut; and
a cylindrical surface 40, of which the radius is equal to the smallest radius of the frustoconical surface 38.

The three cylindrical surfaces 34, 36 and 40 are of circular cross section in a plane perpendicular to the axis 22.

The surface 38 is inclined locally in relation to the axis 22 and is oriented in a direction opposite to the nut.

The screw 14 exhibits a bead 42 at one extremity of its thread 43. The bead carries a relief of trapezoidal section in a plane radial to the axis 22 exhibiting two frustoconical surfaces 44, 46 connected by a cylindrical top surface 48. The two surfaces 44 and 46 are thus inclined in relation to the axis 22 and in a direction opposite thereto. Furthermore, they are oriented in mutually opposing directions with their backs turned. The surface 46 is locally parallel to the frustoconical surface 38 of the bearing.

The jack comprises an adapter 50 exhibiting on its side facing towards the nut 12 an end surface 52 of frustoconical form and inclined locally in relation to the axis 22, in the direction of the latter. This surface is locally parallel to the surface 44. The adapter 50 exhibits in addition a plane end surface with an extremity oriented in the opposite direction to the nut and perpendicular to the axis 22. The adapter 50 is preferably made of aluminum.

The jack also comprises a metallic tensioner 60 exhibiting a generally plane form and extending perpendicularly to the axis 22. It is provided on its external circumference with tongues 62 inclined in relation to the axis 22 in the direction of the latter. These tongues exhibit terminal edges, via which the tensioner comes into engagement with the surface 34 of the bearing for the purpose of their rigid attachment relative to one another. The tensioner 60 is made of steel, for example.

The jack also comprises in the present example two roller bearings, in this case being needle roller bearings 70, 71, each being of frustoconical form. The needle rollers are of cylindrical form and are retained by a bearing cage in a configuration that is inclined in relation to the axis 22. One 71 of the roller bearings is housed between the surfaces 38 and 46, being locally parallel to the latter. The other roller bearing 70 is housed between the surfaces 44 and 52, being locally parallel to the latter.

Finally, the jack comprises four frustoconical washers 72, 73, 74, 75 interposed respectively between:
the surface 38 and the roller bearing 71;
the latter and the surface 46;
the surface 44 and the roller bearing 70; and
the roller bearing 70 and the surface 52.

For assembly of the jack, the following are introduced into the bearing 20 in this order:
the washer 72,
the roller bearing 71,
the washer 73,
the screw 14,
the washer 74,
the other roller bearing 70,
the washer 75,
the adapter 50,
and finally the tensioner 60 force-fitted into the interior of the bearing in such a way as to cause the tongues 62 to engage with the bearing.

All these component parts, apart from the bearing and the screw, exhibit central openings via which they are fed onto the screw.

These elements are in direct mutual axial bearing contact one on the other in this order. The tensioner and the bearing are accordingly biased in the axial direction and in opposite directions, on the one hand at the level of the tongues 62 of the tensioner, and on the other hand at the level of the surface 38. This assembly is carried out in the absence of both axial and radial free play between the component parts, regardless of whether the jack is inoperative or is actuating the movable panel. The tensioner maintains the assembly as a whole under pressure, once assembly has been carried out, thereby taking up any axial free play between the component parts. The assembly is a preloaded assembly. The tensioner 60 forms a spring for taking up the free play. It also ensures the transmission of the axial forces between the jack, the movable panel and the body of the vehicle during operation of the movable panel.

The frustoconical form of the surfaces concerned, in particular the surfaces 38, 46, 44 and 52, ensures the mutual centering of the component parts.

Furthermore, it provides a ball joint coupling between the screw 14 and the bearing, thereby offering it a degree of freedom in addition to its rotation about the axis 22. This ball joint coupling reduces the risks of seeing stresses arise in the bearing during rotation of the screw.

Numerous modifications can, of course, be made to the invention without departing from the scope of the invention.

As an alternative, it is possible to propose making the tensioner 60 and the adapter 50 as a single component part, the component part in this case being made of steel, for example.

1. An actuating jack for a movable panel of a vehicle, comprising characterized in that it comprises:
a nut and endless screw assembly defining an axis;
a bearing, in which an element selected from the group consisting of the nut and the endless screw, is rotatably mounted; and
a tensioner, which is force-fitted into the element or onto the bearing and which biases the latter by means of mutual axial bearing contact when the jack is inoperative.

2. The jack as claimed in claim 1, in which the tensioner is force-fitted onto the bearing.

3. The jack as claimed in claim 1, wherein the tensioner comprises tongues having an edge engaging with the element or the bearing.

4. The jack as claimed in claim 1, wherein the element is in bearing contact with the bearing via at least one surface inclined in relation to the axis.

5. The jack as claimed in claim 1, wherein the element and the bearing exhibit mutual bearing surfaces inclined in relation to the axis.

6. The jack as claimed in claim 1, wherein one or the other of the element or the bearing is in bearing contact with the tensioner via a surface inclined in relation to the axis.

7. The jack as claimed in claim 1, further comprising:
an adapter interposed between the tensioner and the element, and exhibiting a bearing surface perpendicular to the axis and a bearing surface inclined in relation to the axis.

8. The jack as claimed in claim 1, wherein the element and the bearing form a ball joint coupling.

9. The jack as claimed in claim 1, wherein the element exhibits two surfaces in sequence along the axis of the bearing, inclined in relation to the latter and oriented in opposing directions.

10. The jack as claimed claim 1, further comprising:
at least one roller bearing interposed between the element and at least one or the other of the tensioner and the bearing, the one roller bearing or each roller bearing preferably having a generally comprising a frustoconical form.
